(19) United States
(12) Patent Application Publication
(10) Pub. No.: US 2026/0145441 A1
(43) Pub. Date: May 28, 2026

(54) IMAGE FORMING SYSTEM INCLUDING DRYING DEVICE THAT DRIES INK

(71) Applicant: KYOCERA Document Solutions Inc., Osaka (JP)

(72) Inventor: Takuya FUKATA, Osaka (JP)

(73) Assignee: KYOCERA Document Solutions Inc., Osaka (JP)

(21) Appl. No.: 19/387,773

(22) Filed: Nov. 13, 2025

(30) Foreign Application Priority Data
Nov. 27, 2024 (JP) 2024-206773

(51) Int. Cl. B41J 11/00; B41J 29/13; B41J 29/58

(52) U.S. Cl. CPC B41J 11/006; B41J 11/00218; B41J 29/13; B41J 29/58

(57) ABSTRACT

Upon deciding that a plurality of jam detection positions include jam detection positions where jam has occurred, and that the jam detection positions where the jam has occurred include the jam detection position corresponding to a heater unit, a controller of an image forming apparatus instructs a controller of a drying device to move the heater unit from a first position to a second position. And the controller of the image forming apparatus transmits information, indicating that the heater unit is moving from the first position to the second position, to a controller of a display operation device and transmits information, indicating jam occurrence status of all the jam detection positions where the jam has occurred, to the controller of the display operation device.

### INCORPORATION BY REFERENCE

This application claims priority to Japanese Patent Application No.2024-206773 filed on Nov. 27, 2024, the entire contents of which are incorporated by reference herein.

### BACKGROUND

The present disclosure relates to an image forming system, and in particular to an image forming system including a drying device that dries ink ejected onto a sheet.

Image forming systems are known that include a drying device for drying sheets being transported with a heater.

In an electrophotographic apparatus that delivers a sheet to a position corresponding to a photosensitive body position, at a timing adjusted by a pair of resist rollers, and transfers an image on the photosensitive body onto the sheet, thereby recording the image on the sheet, a heater is attached to the resist roller, and a control device is provided that includes a temperature/humidity sensor that detects the ambient temperature and humidity, to control the heater on the basis of the detection result of the sensor. Such a configuration allows the moisture content of the sheet to be constantly maintained at an appropriate level, minimizing a difference in moisture content among the sheets after being dried by heat, originating from the difference in temperature and humidity before the use, thereby preventing defective transfer and occurrence of sheet jam (clogging).

A printing apparatus includes a printing unit that prints an image on a sheet with ink, and a drying unit that dries the sheet being transported with the ink applied thereto by the printing unit. The drying unit blows hot air heated by a heater against the sheet, by circulating the hot air inside a casing, and the casing includes an opening that enables the amount of air flowing into and out of the casing to be adjusted, such that when the transport of the sheet through the drying unit is stopped, the output of the heater is decreased, and the amount of airflow through the opening is increased. Accordingly, when the transport of the sheet through the drying unit is stopped, for example owing to sheet jam, the user can promptly and properly remove the jam. Therefore, the efficiency of maintenance work can be improved.

Further, an image forming apparatus, having the function to form an image on a sheet by applying ink thereto, includes a drying device. The drying device is configured to heat, with a heat source, the sheet to which the ink has been applied, and transported into the drying device through an inlet, and deliver the sheet, on which the ink has been dried, to outside through an outlet. The drying device includes a first shutter that closes the inlet when sheet jam occurs, a second shutter that closes the outlet when sheet jam occurs, a third shutter that disconnects the heat source when sheet jam occurs, a first lock that restricts the first shutter in the closed state from moving in a direction to open the inlet, and a second lock that restricts the second shutter in the closed state from moving in a direction to open the outlet.

### SUMMARY

The disclosure proposes further improvement of the foregoing techniques.

In an aspect, the disclosure provides an image forming system including an image forming apparatus, a drying device, and a display apparatus. The image forming apparatus forms an image on a sheet, by ejecting ink onto the sheet. The drying device dries the ink ejected by the image forming apparatus onto the sheet. The image forming apparatus includes a first casing, a first transport device, an image forming device, and a first control device. The first control device includes a first processor and functions as a first controller when the first processor executes a first control program. The first transport device is located inside the first casing, and transports the sheet. The image forming device is opposed to the first transport device inside the first casing, and ejects the ink onto the sheet. The drying device includes a second casing, a second transport device, a heater unit, a moving mechanism, a cover, and a second control device. The second control device includes a second processor and functions as a second controller when the second processor executes a second control program. The second transport device is located inside the second casing, and transports the sheet. The heater unit is located inside the second casing, and includes a heat source that heats the ink ejected onto the sheet. The moving mechanism is located inside the second casing, and moves the heater unit between a first position opposite the second transport device and in a proximity thereof, and a second position more distant from the second transport device than the first position. The cover covers the heater unit. The display apparatus includes a display device and a third control device. The third control device includes a third processor and functions as a third controller when the third processor executes a third control program. The image forming apparatus and the drying device include a plurality of sensors. The plurality of sensors are respectively provided at a plurality of sensor positions located along a transport route on which the sheet is transported, at positions respectively corresponding to a plurality of jam detection positions on the transport route, and detects jam that occurs at the jam detection position. The plurality of jam detection positions include the jam detection position corresponding to the heater unit. The first controller of the image forming apparatus acts as follows, upon deciding that the plurality of jam detection positions include one or more jam detection positions where the jam has occurred, and that the jam detection positions where the jam has occurred include the jam detection position corresponding to the heater unit, on a basis of a sensing result of each of the sensors. The first controller of the image forming apparatus instructs the second controller of the drying device to move the heater unit from the first position to the second position. The first controller of the image forming apparatus transmits jam removal preparation information, indicating that the heater unit is moving from the first position to the second position, as preparation for removing the jam that has occurred at the jam detection position corresponding to the heater unit, to the third controller of the display apparatus. The first controller of the image forming apparatus transmits jam occurrence status information, indicating jam occurrence status of all the jam detection positions where the jam has occurred, to the third controller of the display apparatus. The second controller of the drying device causes the moving mechanism to move the heater unit from the first position to the second position, in accordance with the instruction. The third controller of the display apparatus causes the display device to display a message indicating that jam removal is under preparation, according to the jam removal preparation information. The third controller of the display apparatus causes the display device to erase the message indicating that jam removal is under preparation, when the heater unit reaches the second position, and display jammed position information including all the jam detection positions where the jam has occurred, on a basis of the jam occurrence status information.

### BRIEF DESCRIPTION OF THE DRAWINGS

FIG. 1 is a perspective view showing the appearance of an image forming system according to a first embodiment of the disclosure;

FIG. 2 is a schematic front cross-sectional view showing a general internal configuration of the image forming system shown in FIG. 1;

FIG. 3 is a block diagram showing connections among control devices of respective components shown in FIG. 1 and FIG. 2;

FIG. 4 is a sequence chart showing a jam removal process executed by the image forming system shown in FIG. 1;

FIG. 5 is another sequence chart showing the jam removal process executed by the image forming system shown in FIG. 1;

FIG. 6 is another sequence chart showing the jam removal process executed by the image forming system shown in FIG. 1;

FIG. 7 is another sequence chart showing the jam removal process executed by the image forming system shown in FIG. 1;

FIG. 8 is a schematic drawing showing an example of jammed position information, displayed on a display operation device 150 shown in FIG. 1;

FIG. 9 is a sequence chart showing a jam removal process executed by an image forming system according to a second embodiment;

FIG. 10 is another sequence chart showing the jam removal process executed by the image forming system according to the second embodiment;

FIG. 11 is another sequence chart showing the jam removal process executed by the image forming system according to the second embodiment;

FIG. 12 is another sequence chart showing the jam removal process executed by the image forming system according to the second embodiment;

FIG. 13 is another sequence chart showing the jam removal process executed by the image forming system according to the second embodiment; and

FIG. 14 is another sequence chart showing the jam removal process executed by the image forming system according to the second embodiment.

### DETAILED DESCRIPTION

Hereafter, an image forming system according to some embodiments of the disclosure will be described, with reference to the drawings.

### First Embodiment

An image forming system 1 according to a first embodiment of the disclosure will be described hereunder, with reference to the drawings.

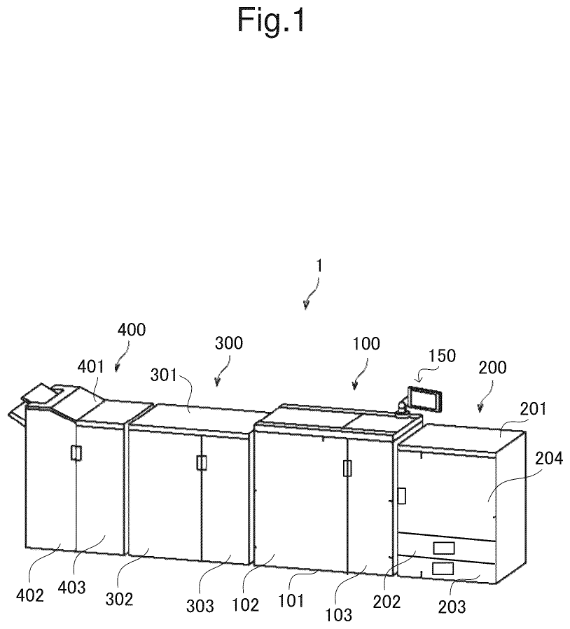

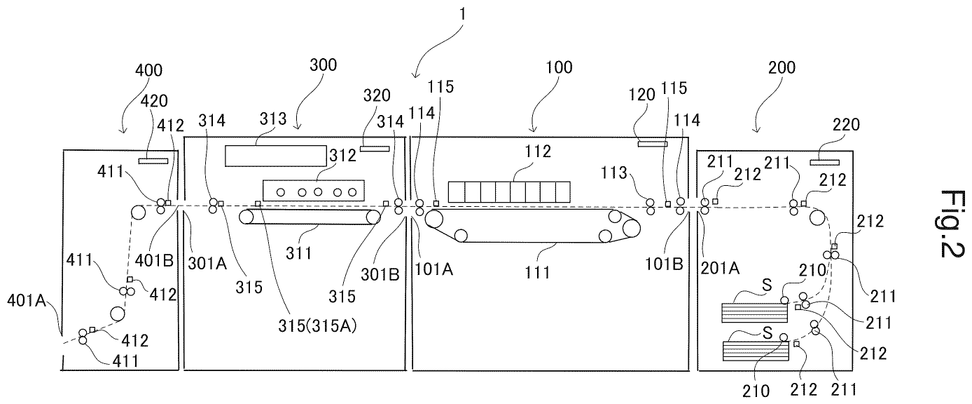

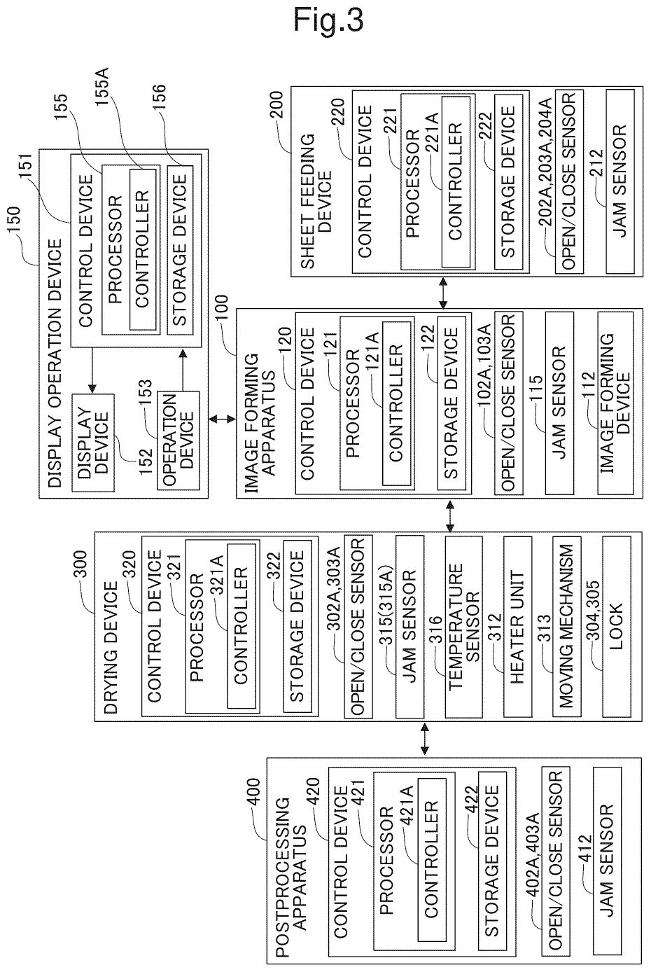

Referring first to FIG. 1, FIG. 2, and FIG. 3, a system configuration of the image forming system 1 according to the first embodiment of the disclosure will be described hereunder. FIG. 1 is a perspective view showing the appearance of the image forming system 1 according to the first embodiment of the disclosure. FIG. 2 is a schematic front cross-sectional view showing a general internal configuration of the image forming system 1. FIG. 3 is a block diagram showing connections among control devices of respective components shown in FIG. 1 and FIG. 2. Hereinafter, the nearer side in FIG. 1 and FIG. 2 will be defined as the front side of an image forming system 1, and the left and right sides will be defined with reference to the image forming system 1 viewed from the front side.

As shown in FIG. 1 and FIG. 2, the image forming system 1 includes the image forming apparatus 100, a display operation device 150, a sheet feeding device 200, a drying device 300, and a postprocessing apparatus 400.

The image forming apparatus 100 and the sheet feeding device 200 respectively include an image forming apparatus-side connector (not shown) and a sheet feeding device-side connector (not shown), for electrically connecting the image forming apparatus 100 and the sheet feeding device 200, and also an image forming apparatus-side mounting mechanism (not shown) and a sheet feeding device-side mounting mechanism (not shown), for removably attaching the sheet feeding device 200 to the image forming apparatus 100. When the sheet feeding device 200 is attached to the image forming apparatus 100, via the image forming apparatus-side mounting mechanism and the sheet feeding device-side mounting mechanism, the image forming apparatus-side connector and the sheet feeding device-side connector are fitted with each other, so that the electrical conduction between the image forming apparatus 100 and the sheet feeding device 200 is established.

The image forming apparatus 100 and the drying device 300 respectively include an image forming apparatus-side connector (not shown) and a drying device-side connector (not shown), for electrically connecting the image forming apparatus 100 and the drying device 300, and also an image forming apparatus-side mounting mechanism (not shown) and a drying device-side mounting mechanism (not shown), for removably attaching the drying device 300 to the image forming apparatus 100. When the drying device 300 is attached to the image forming apparatus 100, via the image forming apparatus-side mounting mechanism and the drying device-side mounting mechanism, the image forming apparatus-side connector and the drying device-side connector are fitted with each other, so that the electrical conduction between the image forming apparatus 100 and the drying device 300 is established.

The drying device 300 and the postprocessing apparatus 400 respectively include a drying device-side connector (not shown) and a postprocessing apparatus-side connector (not shown), for electrically connecting the drying device 300 and the postprocessing apparatus 400, and also a drying device-side mounting mechanism (not shown) and a postprocessing apparatus-side mounting mechanism (not shown), for removably attaching the postprocessing apparatus 400 to the drying device 300. When the postprocessing apparatus 400 is attached to the drying device 300, via the drying device-side mounting mechanism and the postprocessing apparatus-side mounting mechanism, the drying device-side connector and the postprocessing apparatus-side connector are fitted with each other, so that the electrical conduction between the drying device 300 and the postprocessing apparatus 400 is established.

Here, for example the image forming apparatus 100 and the postprocessing apparatus 400 are electrically connected to each other, via the drying device 300.

First, the sheet feeding device 200 will be described. The sheet feeding device 200 supplies sheets S to the image forming apparatus 100.

The sheet feeding device 200 includes a casing 201 of a rectangular parallelepiped shape, sheet cassettes 202 and 203 in each of which the sheets are stored, a cover 204 provided on the front side of the casing 201, and open/close sensors 202A, 203A, and 204A (see FIG. 3) respectively corresponding to the sheet cassettes 202 and 203, and the cover 204. A sheet outlet 201A is provided in the left sidewall of the casing 201. The open/close sensors 202A, 203A, and 204A may be based on a known mechanism, such as a mechanical switch.

The sheet feeding device 200 includes, inside the casing 201, a feeding roller 210 that draws out the sheet S from the sheet cassette 202, and a plurality of transport rollers 211 that each transport the sheet S drawn out from the sheet cassette 202 by the feeding roller 210, toward the downstream side of the transport route. In addition, the sheet feeding device 200 includes, inside the casing 201, another feeding roller 210 that draws out the sheet S from the sheet cassette 203, and a plurality of transport rollers 211 that each transport the sheet S drawn out from the sheet cassette 203 by the feeding roller 210, toward the downstream side of the transport route. Some of the transport rollers 211 serve to transport both of the sheet S drawn out from the sheet cassette 202 and the sheet S drawn out from the sheet cassette 203, toward the downstream side of the transport route.

Further, the sheet feeding device 200 includes jam sensors 212, provided at a plurality of positions (hereinafter, “sensor position” where appropriate) respectively corresponding to a plurality of positions along the transport route, on which the sheet S is transported, inside the casing 201 (hereinafter, “jam detection position” where appropriate), to detect jam that occurs at the jam detection position. The jam sensor 212 may be, for example, an optical sensor. The jam sensor 212 receives, when opposed to the sheet S, light of a first intensity level, reflected by the sheet S at a specific reflectance of the sheet S. When not opposed to the sheet S, the jam sensor 212 receives light of a second intensity level, reflected by an object other than the sheet S at a reflectance different from that of the sheet S. When the jam sensor 212 continuously receives the reflected light of the first intensity level for a predetermined time or longer, the jam sensor 212 detects occurrence of jam at the jam detection position corresponding to that jam sensor 212.

The sheet feeding device 200 includes a control device 220 located inside the casing 201. As shown in FIG. 3, the control device 220 includes a processor 221 and a storage device 222. The processor 221 is, for example, a central processing unit (CPU), a micro processing unit (MPU), or an application-specific integrated circuit (ASIC). The storage device 222 includes a random-access memory (RAM), a read-only memory (ROM), and an electrically erasable programmable read-only memory (EEPROM). The processor 221 acts as a controller 221A, when the processor operates according to a control program stored in the storage device 222. However, the controller 221A may be constituted in the form of a hardware circuit, instead of being realized by the operation of the processor according to the control program. This also applies to other embodiments, unless otherwise specifically noted.

The image forming apparatus 100 will now be described. The image forming apparatus 100 is an inkjet recording apparatus based on the inkjet printing method, which forms an image on the sheet by ejecting ink thereto.

The image forming apparatus 100 includes a casing 101 of a rectangular parallelepiped shape, covers 102 and 103, and open/close sensors 102A and 103A (see FIG. 3) respectively corresponding to the covers 102 and 103. A sheet outlet 101A is provided in the left sidewall of the casing 101, and a sheet inlet 101B is provided in the right sidewall of the casing 101. The open/close sensors 102A and 103A may be based on a known mechanism, such as a mechanical switch.

The image forming apparatus 100 includes, inside the casing 101, a conveying unit 111 that transports the sheet S, adsorbed thereto, toward the downstream side of the transport route.

The image forming apparatus 100 also includes, inside the casing 101, an image forming unit 112 located on the upper side of the conveying unit 111 and opposed thereto, and configured to eject the ink onto the sheet S. The image forming unit 112 includes, for example, four head units. The head unit includes at least one inkjet head, for example three inkjet heads arranged in a checkerboard pattern, and ejects the ink under the control of a controller 121A to be subsequently described. To the four head units, ink containers loaded with the ink of yellow, black, cyan, and magenta, respectively, are connected.

The image forming apparatus 100 also includes, inside the casing 101, a resist roller 113 located upstream of the image forming unit 112, on the transport route of the sheet S. The resist roller 113 is a transport roller that serves to correct the skew of the sheet S when delivering the sheet S to the image forming unit 112 (head unit).

Further, the image forming apparatus 100 includes, inside the casing 101, a plurality of transport rollers 114, respectively located at predetermined positions, to transport the sheet S toward the downstream side on the transport route.

In addition, the image forming apparatus 100 includes jam sensors 115, provided at a plurality of positions (hereinafter, “sensor position” where appropriate) respectively corresponding to a plurality of positions along the transport route, on which the sheet S is transported, inside the casing 101 (hereinafter, “jam detection position” where appropriate), to detect jam that occurs at the jam detection position. The jam sensor 115 may be, for example, an optical sensor. The jam sensor 115 receives, when opposed to the sheet S, light of a first intensity level, reflected by the sheet S at a specific reflectance of the sheet S. When not opposed to the sheet S, the jam sensor 115 receives light of a second intensity level, reflected by the object other than the sheet S at a reflectance different from that of the sheet S. When the jam sensor 115 continuously receives the reflected light of the first intensity level for a predetermined time or longer, the jam sensor 115 detects occurrence of jam at the jam detection position corresponding to that jam sensor 115.

Further, the image forming apparatus 100 includes a control device 120 located inside the casing 101. As shown in FIG. 3, the control device 120 includes a processor 121 and a storage device 122. The processor 121 is, for example, a CPU, an MPU, or an ASIC. The storage device 122 includes a RAM, a ROM, and an EEPROM. The processor 121 acts as a controller 121A, when the processor operates according to a control program stored in the storage device 122. The controller 121A controls the components in the image forming apparatus 100, according to the operation detected by the operation device 153 of the display operation device 150. However, the controller 121A may be constituted in the form of a hardware circuit, instead of being realized by the operation of the processor according to the control program. This also applies to other embodiments, unless otherwise specifically noted.

The display operation device 150 will be described hereunder. The display operation device 150 includes a control device 151 (see FIG. 3), a display device 152 (see FIG. 3) for example including a display panel, and an operation device 153 (see FIG. 3) including a touch panel overlaid on the display panel, and a keypad. The control device 151 includes, as shown in FIG. 3, a processor 155 and a storage device 156. The processor 155 is, for example, a CPU, an MPU, or an ASIC. The storage device 156 includes a RAM, a ROM, and an EEPROM. The processor 155 acts as a controller 155A, when the processor 155 operates according to a control program stored in the storage device 156. For example, the controller 155A causes the display device 152 to display a screen showing the operation menu or status of the image forming apparatus 100. However, the controller 155A may be constituted in the form of a hardware circuit, instead of being realized by the operation of the processor according to the control program. This also applies to other embodiments, unless otherwise specifically noted.

Hereunder, the drying device 300 will be described. The drying device 300 heats the ink ejected onto the sheet, thereby drying the ink.

The drying device 300 includes a casing 301 of a rectangular parallelepiped shape, covers 302 and 303, and open/close sensors 302A and 303A (see FIG. 3) respectively corresponding to the covers 302 and 303. A sheet outlet 301A is provided in the left sidewall of the casing 301, and a sheet inlet 301B is provided in the right sidewall of the casing 301. The open/close sensors 302A and 303A may be based on a known mechanism, such as a mechanical switch.

The drying device 300 includes locks 304 and 305 (see FIG. 3) respectively corresponding to the covers 302 and 303, and configured to lock these covers in the closed state. When the lock 304 or 305 is keeping the cover 302 or 303 locked in the closed state, the user is unable to open the cover 302 or 303. When the cover 302 or 303 is not locked in the closed state, the user can freely open and close the cover 302 or 303.

The drying device 300 includes, inside the casing 301, a conveying unit 311 that transports the sheet S, adsorbed thereto, toward the downstream side of the transport route.

The drying device 300 includes a heater unit 312, located on the upper side of the conveying unit 311 inside the casing 301, and having a plurality of heat sources that each heat the ink ejected onto the sheet. The heater unit 312 includes a casing of a rectangular parallelepiped shape open toward the lower side, in which the heat sources are located. The heat sources each have a bar shape elongate in the front-rear direction, and aligned at regular intervals in the transport direction, with the front and rear ends fixed to the casing. Examples of the heat source include a halogen heater, a carbon heater, an infrared light-emitting diode (LED), and a ceramic heater.

The drying device 300 includes a moving mechanism 313 located inside the casing 301, and configured to move the heater unit 312 between a first position opposite the conveying unit 311 and in a proximity thereof, and a second position more distant from the conveying unit 311 than the first position. In this embodiment, the moving mechanism 313 moves the heater unit 312 in the up-down direction. The first position corresponds to the position of the heater unit 312 where the ink ejected by the image forming apparatus 100 onto the sheet S is heated and dried, and will hereinafter be referred to as “printing position”, where appropriate. The second position corresponds to the position of the heater unit 312, assumed when the jam that occurred at the jam detection position corresponding to the heater unit 312 is removed, and will hereinafter be referred to as “jam removal position”, where appropriate. For example, the moving mechanism 313 includes a first belt attached to an end portion of the heater unit 312, a second belt attached to the other end portion thereof, a first roller that takes up or unreels the first belt, a second roller that takes up or unreels the second belt, a first drive motor that rotates the first roller in the forward or reverse direction, and a second drive motor that rotates the second roller in the forward or reverse direction. When the first belt and the second belt are taken up, the heater unit 312 is moved from the first position (printing position) to the second position (jam removal position), and when the first belt and the second belt are unreeled, the heater unit 312 is moved from the second position (jam removal position) to the first position (printing position). Here, the configuration of the moving mechanism 313 is not specifically limited, provided that the mechanism enables the heater unit 312 to move between the first position (printing position) and the second position (jam removal position).

The drying device 300 includes, inside the casing 301, a plurality of transport rollers 314, respectively located at predetermined positions, to transport the sheet S toward the downstream side on the transport route.

The drying device 300 includes jam sensors 315, provided at a plurality of positions (sensor positions) respectively corresponding to a plurality of positions along the transport route, on which the sheet S is transported, inside the casing 301 (jam detection positions), to detect jam that occurs at the jam detection position. The plurality of jam detection positions include the jam detection positions corresponding to the heater unit 312, and the plurality of jam sensors 315 are respectively provided at the jam detection positions corresponding to the heater unit 312, and include the jam sensor 315 that detects the jam that occurs at the jam detection position. Hereinafter, the jam sensor 315 provided at the jam detection position corresponding to the heater unit 312, to detect the jam that occurs at this jam detection position, will be referred to as “jam sensor 315A”, where appropriate. The jam sensor 315 may be, for example, an optical sensor. The jam sensor 315 receives, when opposed to the sheet S, light of a first intensity level, reflected by the sheet S at a specific reflectance of the sheet S. When not opposed to the sheet S, the jam sensor 315 receives light of a second intensity level, reflected by the object other than the sheet S at a reflectance different from that of the sheet S. When the jam sensor 315 continuously receives the reflected light of the first intensity level for a predetermined time or longer, the jam sensor 315 detects occurrence of jam at the jam detection position corresponding to that jam sensor 315.

The drying device 300 also includes a temperature sensor 316 (see FIG. 3) that detects the temperature of a region in the proximity of the heater unit 312.

The drying device 300 includes a control device 320 located inside the casing 301. As shown in FIG. 3, the control device 320 includes a processor 321 and a storage device 322. The processor 321 is, for example, a CPU, an MPU, or an ASIC. The storage device 322 includes a RAM, a ROM, and an EEPROM. The processor 321 acts as a controller 321A, when the processor operates according to a control program stored in the storage device 322. However, the controller 321A may be constituted in the form of a hardware circuit, instead of being realized by the operation of the processor 321 according to the control program. This also applies to other embodiments, unless otherwise specifically noted.

Hereunder, the postprocessing apparatus 400 will be described. The postprocessing apparatus 400 performs postprocessing on the sheet, such as punching, stapling, and folding.

The postprocessing apparatus 400 includes a casing 401 of a rectangular parallelepiped shape, covers 402 and 403, and open/close sensors 402A and 403A (see FIG. 3) respectively corresponding to the covers 402 and 403. A sheet outlet 401A is provided in the left sidewall of the casing 401, and a sheet inlet 401B is provided in the right sidewall of the casing 401. The open/close sensors 402A and 403A may be based on a known mechanism, such as a mechanical switch.

The postprocessing apparatus 400 includes, inside the casing 401, a plurality of transport rollers 411, respectively located at predetermined positions, to transport the sheet S toward the downstream side on the transport route.

The postprocessing apparatus 400 includes jam sensors 412, provided at a plurality of positions (sensor positions) respectively corresponding to a plurality of positions along the transport route, on which the sheet S is transported, inside the casing 401 (jam detection positions), to detect jam that occurs at the jam detection position. The jam sensor 412 may be, for example, an optical sensor. The jam sensor 412 receives, when opposed to the sheet S, light of a first intensity level, reflected by the sheet S at a specific reflectance of the sheet S. When not opposed to the sheet S, the jam sensor 412 receives light of a second intensity level, reflected by the object other than the sheet S at a reflectance different from that of the sheet S. When the jam sensor 412 continuously receives the reflected light of the first intensity level for a predetermined time or longer, the jam sensor 412 detects occurrence of jam at the jam detection position corresponding to that jam sensor 412.

The postprocessing apparatus 400 includes a control device 420 located inside the casing 401. As shown in FIG. 3, the control device 420 includes a processor 421 and a storage device 422. The processor 421 is, for example, a CPU, an MPU, or an ASIC. The storage device 422 includes a RAM, a ROM, and an EEPROM. The processor 421 acts as a controller 421A, when the processor operates according to a control program stored in the storage device 422. However, the controller 421A may be constituted in the form of a hardware circuit, instead of being realized by the operation of the processor 421 according to the control program. This also applies to other embodiments, unless otherwise specifically noted.

In the case of deciding, on the basis of the sensing result of each of the jam sensors, that the plurality of jam detection positions include the jam detection positions where the jam has occurred, and that the jam detection positions where the jam has occurred include the jam detection position corresponding to the heater unit 312, the controller 121A of the image forming apparatus 100 instructs the controller 321A of the drying device 300 to move the heater unit 312 from the first position to the second position, and transmits jam removal preparation information, indicating that the heater unit 312 is moving from the first position to the second position, as preparation for removing the jam that has occurred at the jam detection position corresponding to the heater unit 312, to the controller 155A of the display operation device 150. The controller 121A of the image forming apparatus 100 then transmits jam occurrence status information, indicating the jam occurrence status of all the jam detection positions where the jam has occurred, to the controller 155A of the display operation device 150. The controller 321A of the drying device 300 causes the moving mechanism 313 to move the heater unit 312 from the first position to the second position, in accordance with the moving instruction. The controller 155A of the display operation device 150 causes the display device 152 to display a message indicating that jam removal is under preparation, according to the jam removal preparation information. When the heater unit 312 reaches the second position, the controller 155A of the display operation device 150 causes the display device 152 to erase the message indicating that jam removal is under preparation, and display jammed position information including all the jam detection positions where the jam has occurred, on the basis of the jam occurrence status information.

Although the controller 121A, the controller 155A, and the controller 321A are separately provided as independent devices, a single controller may be configured so as to act as the controller 121A, the controller 155A, and the controller 321A.

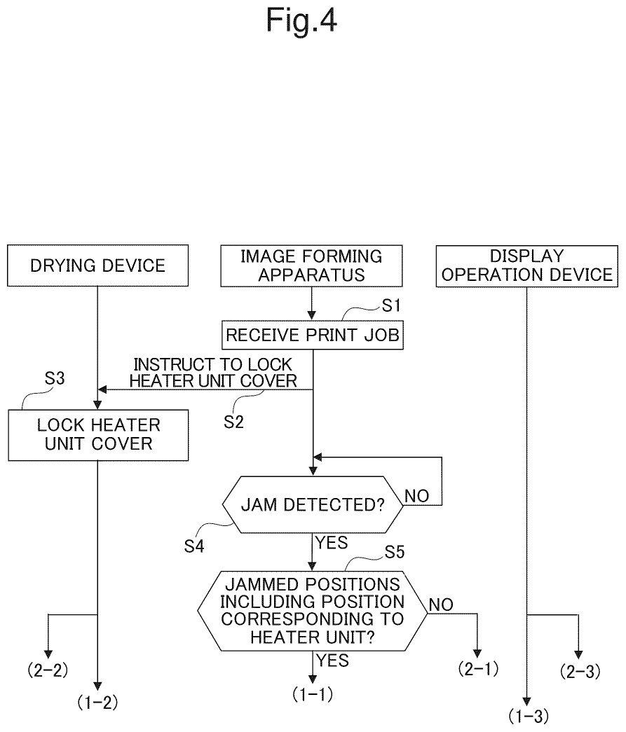

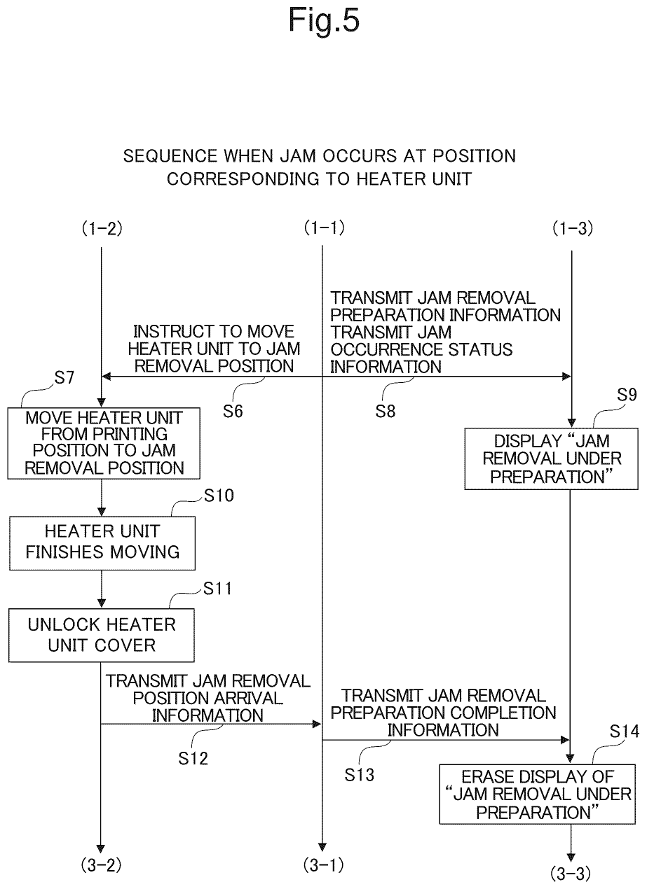

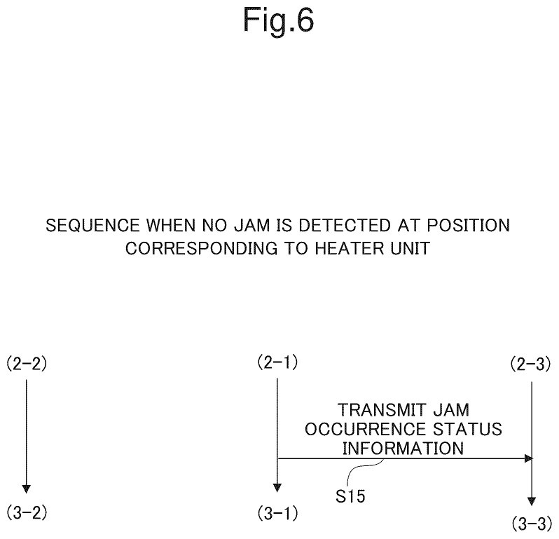

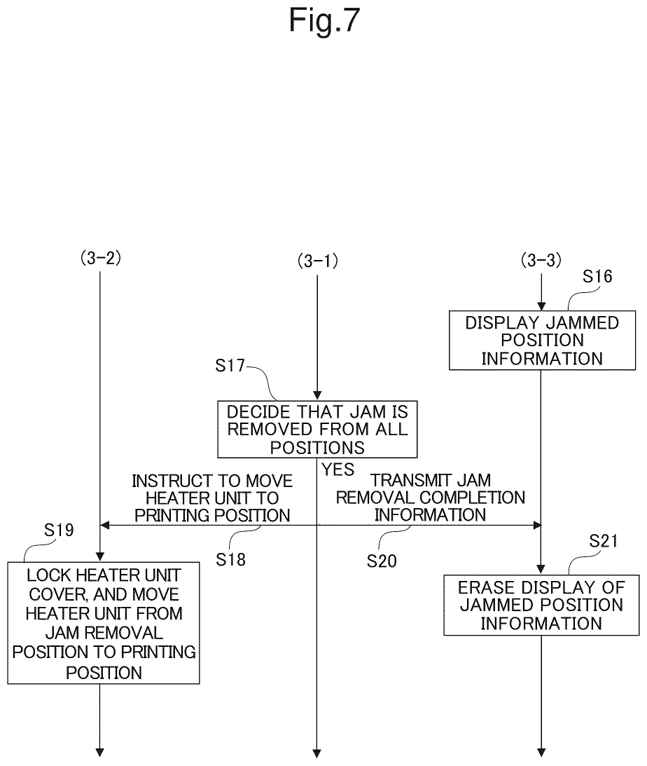

Referring now to FIG. 4 to FIG. 7, a jam removal process executed by the image forming system 1 shown in FIG. 1 will be described hereunder. FIG. 4 to FIG. 7 are sequence charts each showing the jam removal process executed by the image forming system 1 shown in FIG. 1.

The controller 121A of the image forming apparatus 100 receives a print job and starts the printing operation (step S1), and instructs the controller 321A of the drying device 300 to turn on the heat source of the heater unit 312, and to lock the covers 302 and 303 of the heater unit 312 (step S2). The controller 321A of the drying device 300 turns on the heat source of the heater unit 312, and locks, when the lock for keeping the covers 302 and 303 closed is unlocked, the covers 302 and 303 with the locks 304 and 305, respectively (step S3).

The controller 121A of the image forming apparatus 100 acquires the sensing result from each of the plurality of jam sensors 115 provided in the image forming apparatus 100, the sensing result from each of the plurality of jam sensors 212 provided in the sheet feeding device 200, via the controller 221A thereof, the sensing result from each of the plurality of jam sensors 315 (sensor 315A inclusive) provided in the drying device 300, via the controller 321A thereof, and the sensing result from each of the plurality of jam sensors 412 provided in the postprocessing apparatus 400, via the controller 421A thereof and the controller 321A of the drying device 300. Then the controller 121A of the image forming apparatus 100 decides, on the basis of the sensing result acquired from the plurality of jam sensors 115, 212, 315 (315A inclusive), and 412, whether jam has occurred (occurrence of jam has been detected) at any of the jam detection positions, among the plurality of jam detection positions (including the plurality of jam detection positions in the image forming apparatus 100, the plurality of jam detection positions in the sheet feeding device 200, the plurality of jam detection positions in the drying device 300, and the plurality of jam detection positions in the postprocessing apparatus 400) (step S4). When it is decided at step S4 that the jam has not occurred (occurrence of jam has not been detected) at any of the jam detection positions (NO at S4), the operation of step S4 is repeated.

When it is decided at step S4 that the jam has occurred (occurrence of jam has been detected) at one or more jam detection positions (YES at S4), the controller 121A of the image forming apparatus 100 decides whether the jam detection positions where the jam has occurred include the jam detection position corresponding to the heater unit 312 (whether the sheet is present at the jam detection position corresponding to the heater unit 312) (step S5).

The sequence to be followed when the jam has occurred at the jam detection position corresponding to the heater unit 312 leads to (1-1), (1-2), and (1-3), and the sequence to be followed when the jam has not occurred at the jam detection position corresponding to the heater unit 312 leads to (2-1), (2-2), and (2-3).

The sequence subsequent to (1-1), (1-2), and (1-3), to be followed when the jam has occurred at the jam detection position corresponding to the heater unit 312, is as described below.

When it is decided at step S5 that the jam detection positions where the jam has occurred include the jam detection position corresponding to the heater unit 312 (YES at S5), the controller 121A of the image forming apparatus 100 instructs the controller 321A of the drying device 300 to move the heater unit 312 from the first position (printing position) to the second position (jam removal position) (step S6). The controller 321A of the drying device 300 turns off the heat source of the heater unit 312, and causes the moving mechanism 313 to start to move the heater unit 312 from the first position (printing position) toward the second position (jam removal position), when the temperature detected by the temperature sensor 316 becomes equal to or lower than a predetermined temperature (step S7).

The controller 121A of the image forming apparatus 100 transmits jam removal preparation information indicating that the heater unit 312 is moving from the first position (printing position) toward the second position (jam removal position), as preparation for removal of the jam that has occurred in the drying device 300 at the jam detection position corresponding to the heater unit 312, and jam occurrence status information indicating the jam occurrence status of all the jam detection positions where the jam has occurred, to the controller 155A of the display operation device 150 (step S8).

Upon receipt of the drying device jam removal preparation information, the controller 155A of the display operation device 150 causes the display device 152 to display “Jam Removal Under Preparation” indicating that the jam removal operation in the drying device is being prepared (step S9).

When the heater unit 312 is made to reach the second position (jam removal position) by the moving mechanism 313 (step S10), the controller 321A of the drying device 300 causes the locks 304 and 305 to cancel the lock keeping the heater unit covers 302 and 303 closed (step S11), and transmits jam removal position arrival information indicating that the heater unit 312 has reached the second position (jam removal position), to the controller 121A of the image forming apparatus 100 (step S12). Upon receipt of the jam removal position arrival information, the controller 121A of the image forming apparatus 100 transmits jam removal preparation completion information indicating that the preparation for removal of the jam that has occurred at the jam detection position corresponding to the heater unit 312 has been completed, to the controller 155A of the display operation device 150 (step S13).

The controller 155A of the display operation device 150 causes the display device 152 to erase the display of “Jam Removal Under Preparation”, according to the jam removal preparation completion information received (step S14). The sequence to be followed leads to (3-1), (3-2), and (3-3).

The sequence subsequent to (2-1), (2-2), and (2-3), to be followed when the jam has not occurred at the jam detection position corresponding to the heater unit 312, is as described below.

When it is decided at step S5 that the jam detection positions where the jam has occurred do not include the jam detection position corresponding to the heater unit 312 (NO at S5), the controller 121A of the image forming apparatus 100 transmits jam occurrence status information indicating the jam occurrence status of all the jam detection positions where the jam has occurred, to the controller 155A of the display operation device 150 (step S15). The sequence to be followed leads to (3-1), (3-2), and (3-3).

The sequence subsequent to (3-1), (3-2), and (3-3) is as described below.

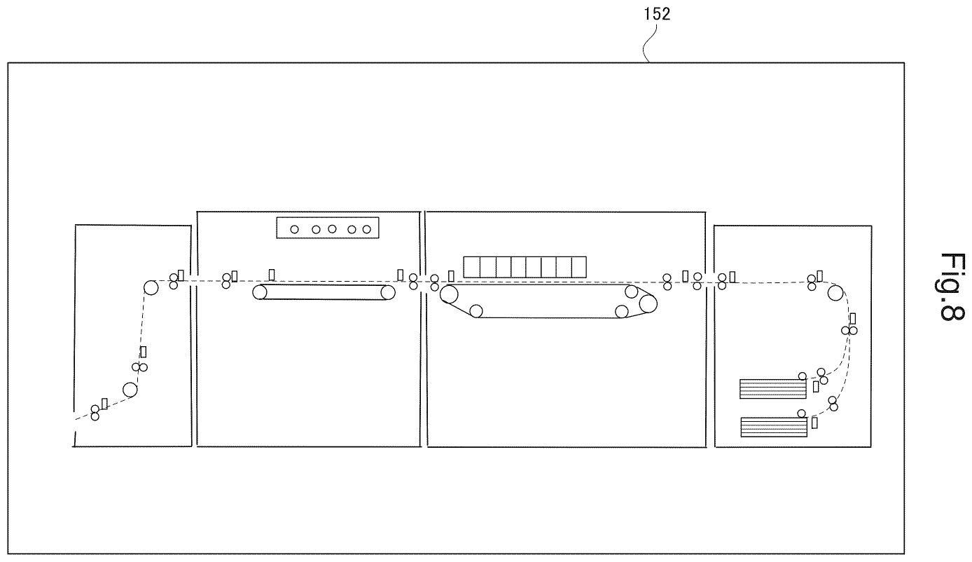

The controller 155A of the display operation device 150 causes the display device 152 to display jammed position information, including all the jam detection positions where the jam has occurred, on the basis of the jam occurrence status information (step S16). FIG. 8 illustrates an example of the jammed position information displayed on the display device 152. In the jammed position information displayed on the display device 152, the positions corresponding to the plurality of jam detection position are, for example, marked by rectangles, such that the jam detection position where the jam has occurred is indicated by a black rectangle, and the jam detection position where the jam has not occurred is indicated by a white rectangle.

In view of the display of the jammed position information on the display device 152, the user opens the covers respectively corresponding to the jam detection positions where the jam has occurred, removes the jam, and closes the covers. The controller 121A of the image forming apparatus 100 acquires the sensing result from each of the open/close sensors 102A and 103A provided in the image forming apparatus 100, the sensing result from each of the open/close sensors 202A, 203A, and 204A provided in the sheet feeding device 200, via the controller 221A thereof, the sensing result from each of the open/close sensors 302A and 303A provided in the drying device 300, via the controller 321A thereof, and the sensing result from each of the open/close sensors 402A and 403A provided in the postprocessing apparatus 400, via the controller 421A thereof and the controller 321A of the drying device 300. The controller 121A of the image forming apparatus 100 detects that the sheet cassettes and the covers, which were once opened, have been closed, on the basis of the sensing result acquired from each of the plurality of open/close sensors 102A, 103A, 202A, 203A, 204A, 302A, 303A, 402A, and 403A. Then the controller 121A of the image forming apparatus 100 acquires the sensing result from each of the plurality of jam sensors 115 provided in the image forming apparatus 100, the sensing result from each of the plurality of jam sensors 212 provided in the sheet feeding device 200, via the controller 221A thereof, the sensing result from each of the plurality of jam sensors 315 (315A inclusive) provided in the drying device 300, via the controller 321A thereof, and the sensing result from each of the plurality of jam sensors 412 provided in the postprocessing apparatus 400, via the controller 421A thereof and the controller 321A of the drying device 300. The controller 121A of the image forming apparatus 100 then decides whether the jam has been removed from all the positions where the jam occurred, on the basis of the sensing result acquired from each of the plurality of jam sensors 115, 212, 315 (315A inclusive), and 412.

The controller 121A of the image forming apparatus 100 decides that the jam has been removed from all the jam detection positions where the jam occurred (step S17).

While the user is removing the jam, the controller 121A of the image forming apparatus 100 acquires, time after time, the sensing result from each of the plurality of jam sensors, and transmits the jam occurrence status information to the controller 155A of the display operation device 150. The controller 155A of the display operation device 150 causes the display device 152 to update the display of the jammed position information.

The controller 121A of the image forming apparatus 100 instructs the controller 321A of the drying device 300 to move the heater unit 312 from the second position (jam removal position) to the first position (printing position) (step S18). The controller 321A of the drying device 300 causes the locks 304 and 305 to lock the heater unit covers 302 and 303 in the closed state, when the lock for keeping the heater unit covers 302 and 303 closed is unlocked, causes the moving mechanism 313 to move the heater unit 312 from the second position (jam removal position) to the first position (printing position), and turns on the heat source of the heater unit 312 (step S19).

The controller 121A of the image forming apparatus 100 transmits jam removal completion information indicating that the jam has been removed from all the positions where the jam occurred, to the controller 155A of the display operation device 150 (step S20).

The controller 155A of the display operation device 150 causes the display device 152 to erase the display of the jammed position information, according to the jam removal completion information received (step S21).

The image forming system 1 resumes the printing operation.

According to the first embodiment, when jam occurs at the jam detection position corresponding to the heater unit 312, the jam removal preparation information indicating that the heater unit 312 is moving from the first position (printing position) toward the second position (jam removal position), as preparation for removing the jam that has occurred at the jam detection position corresponding to the heater unit 312, is displayed on the display device 152. Therefore, the user can be made aware that the jam has occurred at the jam detection position corresponding to the heater unit 312, and also that the preparation for removal of the jam is under preparation, by which the user can be exempted from feeling irritated. In addition, when the heater unit 312 reaches the second position (jam removal position), the jam detection position corresponding to the heater unit 312 is displayed on the display device 152, and therefore the user can promptly start the operation to remove the jam that has occurred at the jam detection position corresponding to the heater unit 312, as soon as the heater unit 312 reaches the second position (jam removal position).

### Second Embodiment

Hereunder, the image forming system 1 according to a second embodiment of the disclosure will be described, with reference to the drawings. The image forming system 1 according to the second embodiment is different from the image forming system 1 according to the first embodiment, in the operation performed when occurrence of jam is detected at some jam detection positions, and the jam detection positions where the jam has been detected include the jam detection position corresponding to the heater element of the heater unit.

The controller 155A of the display operation device 150 of the image forming system 1 according to the first embodiment causes the display device 152 to display “Jam Removal Under Preparation” indicating that the jam removal is under preparation, according to the jam removal preparation information. When the heater unit 312 reaches the second position, the controller 155A of the display operation device 150 causes the display device 152 to erase the display of “Jam Removal Under Preparation” indicating that the jam removal is under preparation, and to display the jammed position information including all the jam detection positions where the jam has occurred, on the basis of the jam occurrence status information.

In contrast, the controller 155A of the display operation device 150 of the image forming system 1 according to the second embodiment causes the display device 152 to display first jammed position information, including all the jam detection positions except the jam detection position corresponding to the heater unit 312, among the plurality of jam detection positions where the jam has occurred, on the basis of the jam occurrence status information. In the case where the heater unit 312 has not reached the second position, by the time that the jam is removed from all the jam detection positions, except the jam detection position corresponding to the heater unit 312, the controller 155A of the display operation device 150 causes the display device 152 to display “Jam Removal Under Preparation” indicating that the jam removal is under preparation, according to the jam removal preparation information. When the heater unit 312 reaches the second position, the controller 155A of the display operation device 150 causes the display device 152 to erase the display of “Jam Removal Under Preparation” indicating that the jam removal is under preparation, and to display second jammed position information, including only the jam detection position corresponding to the heater unit.

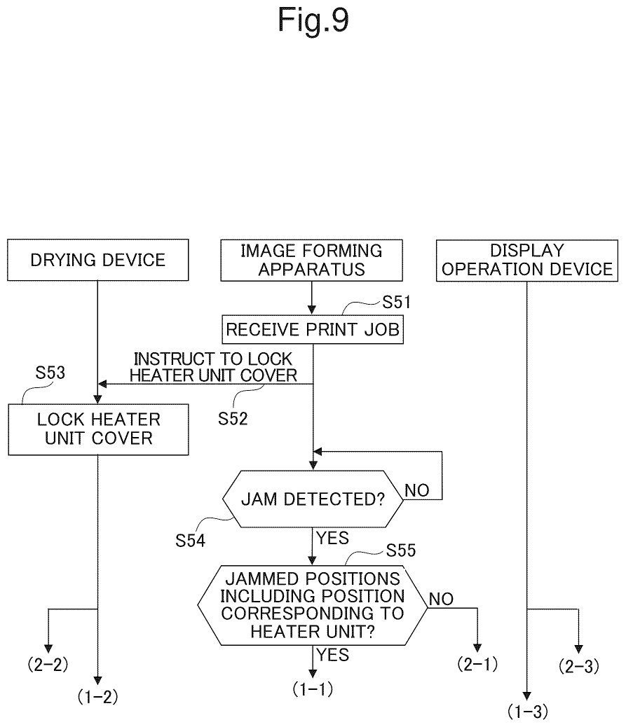

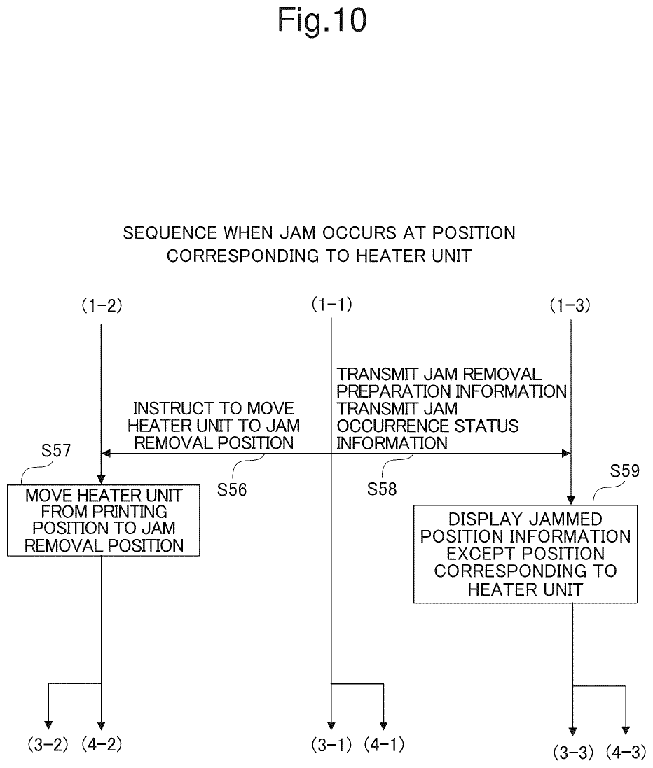

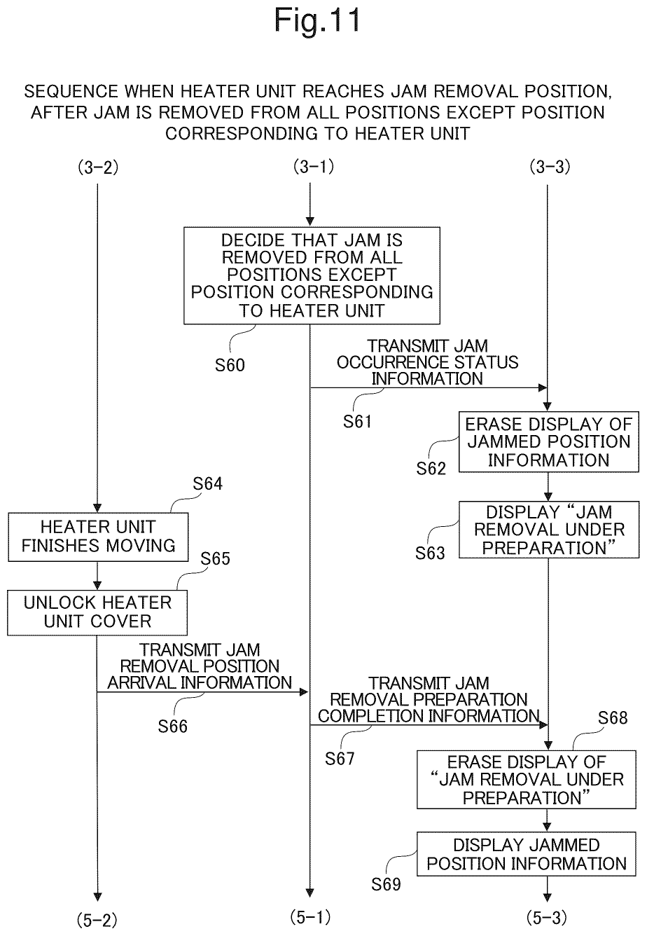

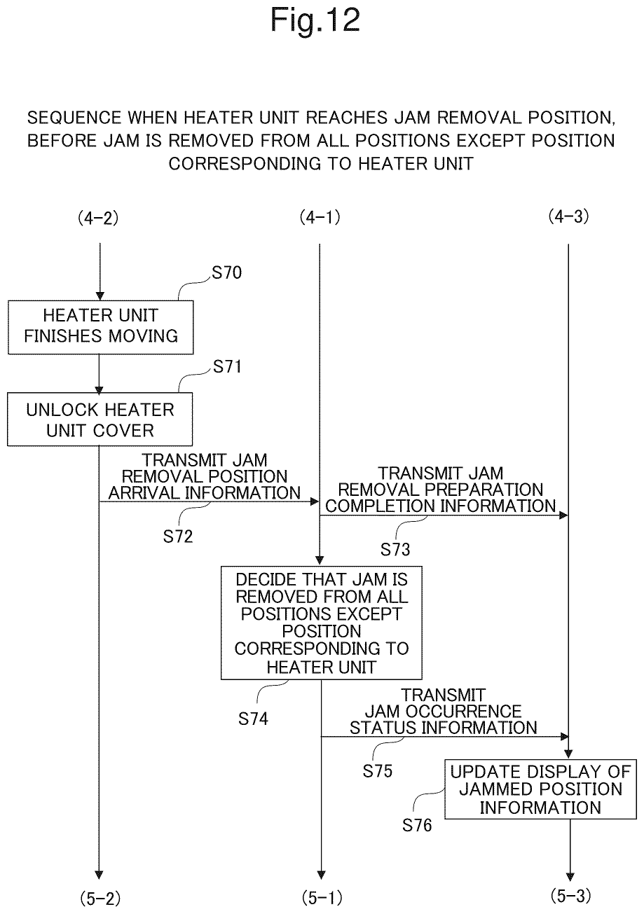

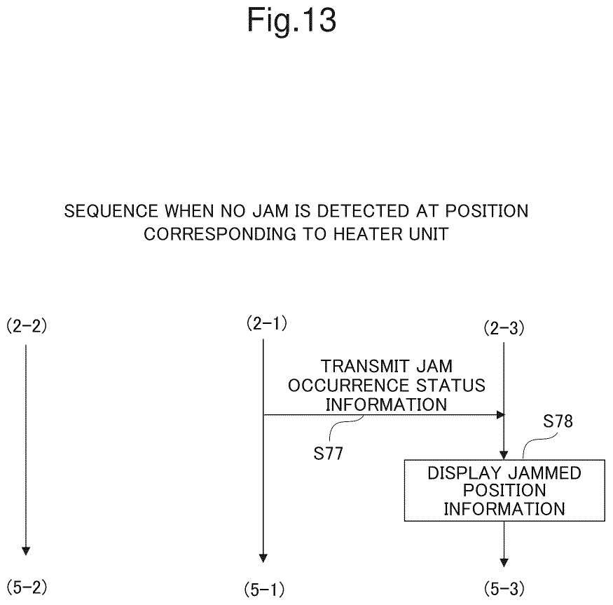

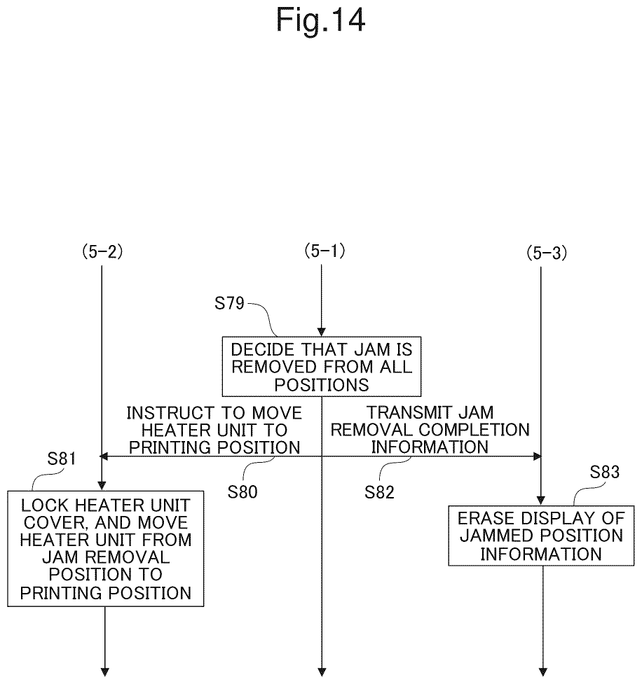

Referring now to FIG. 9 to FIG. 14, a jam removal process executed by the image forming system 1 according to the second embodiment will be described hereunder. FIG. 9 to FIG. 14 are sequence charts each showing the jam removal process executed by the image forming system 1 according to the second embodiment.

The image forming system 1 according to the second embodiment executes the operation of steps S51 to step S55, which are the same as steps S1 to step S5 executed by the image forming system 1 according to the first embodiment. The sequence to be followed when jam has occurred at the jam detection position corresponding to the heater unit 312 leads to (1-1), (1-2), and (1-3), and the sequence to be followed when jam has not occurred at the jam detection position corresponding to the heater unit 312 leads to (2-1), (2-2), and (2-3).

The image forming system 1 according to the second embodiment executes the operation of steps S56 to step S58, which are the same as steps S6 to step S8 executed by the image forming system 1 according to the first embodiment.

The controller 155A of the display operation device 150 causes the display device 152 to display the jammed position information, including all the jam detection positions except the jam detection position corresponding to the heater unit 312, among the plurality of jam detection positions where the jam has occurred, on the basis of the jam occurrence status information (step S59).

In view of the display of the jammed position information on the display device 152, the user removes the jam. In this case, the heater unit 312 may reach the second position (jam removal position), either before the user removes the jam at all the jam detection positions except the jam detection position corresponding to the heater unit 312, or after the user has removed the jam at all the jam detection positions except the jam detection position corresponding to the heater unit 312. In the latter case, the sequence leads to (3-1), (3-2), and (3-3), and in the former case the sequence leads to (4-1), (4-2), and (4-3).

The sequence subsequent to (3-1), (3-2), and (3-3), to be followed when the heater unit 312 reaches the second position (jam removal position) after the user has removed the jam at all the jam detection positions except the jam detection position corresponding to the heater unit 312, is as described below.

In view of the display of the jammed position information on the display device 152, the user opens the covers respectively corresponding to the jam detection positions where the jam has occurred, except the jam detection position corresponding to the heater unit 312, removes the jam, and closes the covers. The controller 121A of the image forming apparatus 100 acquires the sensing result from each of the open/close sensors 102A and 103A provided in the image forming apparatus 100, the sensing result from each of the open/close sensors 202A, 203A, and 204A provided in the sheet feeding device 200, via the controller 221A thereof, the sensing result from each of the open/close sensors 302A and 303A provided in the drying device 300, via the controller 321A thereof, and the sensing result from each of the open/close sensors 402A and 403A provided in the postprocessing apparatus 400, via the controller 421A thereof and the controller 321A of the drying device 300. The controller 121A of the image forming apparatus 100 detects that the sheet cassettes and the covers, which were once opened, have been closed, on the basis of the sensing result acquired from each of the plurality of open/close sensors 102A, 103A, 202A, 203A, 204A, 302A, 303A, 402A, and 403A. Then the controller 121A of the image forming apparatus 100 acquires the sensing result from each of the plurality of jam sensors 115 provided in the image forming apparatus 100, the sensing result from each of the plurality of jam sensors 212 provided in the sheet feeding device 200, via the controller 221A thereof, the sensing result from each of the plurality of jam sensors 315 (315A inclusive) provided in the drying device 300, via the controller 321A thereof, and the sensing result from each of the plurality of jam sensors 412 provided in the postprocessing apparatus 400, via the controller 421A thereof and the controller 321A of the drying device 300. The controller 121A of the image forming apparatus 100 then decides whether the jam has been removed from all the positions where the jam occurred, except the jam detection position corresponding to the heater unit 312, on the basis of the sensing result acquired from each of the plurality of jam sensors 115, 212, 315 (315A inclusive), and 412.

The controller 121A of the image forming apparatus 100 decides that the jam has been removed from all the jam detection positions where the jam occurred, except the jam detection position corresponding to the heater unit 312 (step S60).

While the user is removing the jam, other than the jam at the jam detection position corresponding to the heater unit 312, the controller 121A of the image forming apparatus 100 acquires, time after time, the sensing result from each of the plurality of jam sensors, and transmits the jam occurrence status information to the controller 155A of the display operation device 150. The controller 155A of the display operation device 150 causes the display device 152 to update the display of the jammed position information, including all the jam detection positions except the jam detection position corresponding to the heater unit 312, among the plurality of jam detection positions where the jam has occurred.

The controller 121A of the image forming apparatus 100 transmits the jam occurrence status information including all the jam detection positions where the jam has occurred, to the controller 155A of the display operation device 150 (step S61). The jam occurrence status information transmitted at step S61 only includes the jam detection position corresponding to the heater unit 312, as the jam detection position where the jam has occurred.

The controller 155A of the display operation device 150 causes the display device 152 to erase the display of the jam occurrence status information (step S62), because of recognizing that the jam detection position corresponding to the heater unit 312 has now become the only jam detection position where the jam has occurred, before receiving the jam removal preparation completion information, on the basis of the jam occurrence status information only including the jam detection position corresponding to the heater unit 312, and causes the display device 152 to display “Jam Removal Under Preparation” indicating that the jam removal is under preparation, on the basis of the jam removal preparation information (step S63).

When the heater unit 312 is made to reach the second position (jam removal position) by the moving mechanism 313 (step S64), after the user has removed the jam of all the jam detection positions except the jam detection position corresponding to the heater unit 312, the controller 321A of the drying device 300 causes the locks 304 and 305 to cancel the lock keeping the heater unit covers 302 and 303 closed (step S65), and transmits jam removal position arrival information indicating that the heater unit 312 has reached the second position (jam removal position), to the controller 121A of the image forming apparatus 100 (step S66). Upon receipt of the jam removal position arrival information, the controller 121A of the image forming apparatus 100 transmits the jam removal preparation completion information indicating that the preparation for removal of the jam that has occurred at the jam detection position corresponding to the heater unit 312 has been completed, to the controller 155A of the display operation device 150 (step S67).

The controller 155A of the display operation device 150 causes the display device 152 to erase the display of “Jam Removal Under Preparation”, according to the jam removal preparation completion information received (step S68).

The controller 155A of the display operation device 150 causes the display device 152 to display the jammed position information, including all the jam detection positions where the jam has occurred (in this case only the jam detection position corresponding to the heater unit 312, since this is the only position where the jam has occurred), on the basis of the jam occurrence status information (step S69). The sequence leads to (5-1), (5-2), and (5-3).

The sequence subsequent to (4-1), (4-2), and (4-3), to be followed when the heater unit 312 has reached the second position (jam removal position), by the time that the user removes the jam at all the jam detection positions except the jam detection position corresponding to the heater unit 312, is as described below.

When the heater unit 312 is made to reach the second position (jam removal position) by the moving mechanism 313 (step S70), before the user removes the jam of all the jam detection positions except the jam detection position corresponding to the heater unit 312, the controller 321A of the drying device 300 causes the locks 304 and 305 to cancel the lock keeping the heater unit covers 302 and 303 closed (step S71), and transmits jam removal position arrival information indicating that the heater unit 312 has reached the second position (jam removal position), to the controller 121A of the image forming apparatus 100 (step S72). Upon receipt of the jam removal position arrival information, the controller 121A of the image forming apparatus 100 transmits the jam removal preparation completion information indicating that the preparation for removal of the jam that has occurred at the jam detection position corresponding to the heater unit 312 has been completed, to the controller 155A of the display operation device 150 (step S73).

In view of the display of the jammed position information on the display device 152, the user opens the covers respectively corresponding to the jam detection positions where the jam has occurred, except the jam detection position corresponding to the heater unit 312, removes the jam, and closes the covers. The controller 121A of the image forming apparatus 100 acquires the sensing result from each of the open/close sensors 102A and 103A provided in the image forming apparatus 100, the sensing result from each of the open/close sensors 202A, 203A, and 204A provided in the sheet feeding device 200, via the controller 221A thereof, the sensing result from each of the open/close sensors 302A and 303A provided in the drying device 300, via the controller 321A thereof, and the sensing result from each of the open/close sensors 402A and 403A provided in the postprocessing apparatus 400, via the controller 421A thereof and the controller 321A of the drying device 300. The controller 121A of the image forming apparatus 100 detects that the sheet cassettes and the covers, which were once opened, have been closed, on the basis of the sensing result acquired from each of the plurality of open/close sensors 102A, 103A, 202A, 203A, 204A, 302A, 303A, 402A, and 403A. Then the controller 121A of the image forming apparatus 100 acquires the sensing result from each of the plurality of jam sensors 115 provided in the image forming apparatus 100, the sensing result from each of the plurality of jam sensors 212 provided in the sheet feeding device 200, via the controller 221A thereof, the sensing result from each of the plurality of jam sensors 315 (315A inclusive) provided in the drying device 300, via the controller 321A thereof, and the sensing result from each of the plurality of jam sensors 412 provided in the postprocessing apparatus 400, via the controller 421A thereof and the controller 321A of the drying device 300. The controller 121A of the image forming apparatus 100 then decides whether the jam has been removed from all the positions where the jam occurred, except the jam detection position corresponding to the heater unit 312, on the basis of the sensing result acquired from each of the plurality of jam sensors 115, 212, 315 (315A inclusive), and 412.

The controller 121A of the image forming apparatus 100 decides that the jam has been removed from all the jam detection positions where the jam occurred, except the jam detection position corresponding to the heater unit 312 (step S74).

While the user is removing the jam, other than the jam at the jam detection position corresponding to the heater unit 312, the controller 121A of the image forming apparatus 100 acquires, time after time, the sensing result from each of the plurality of jam sensors, and transmits the jam occurrence status information to the controller 155A of the display operation device 150. The controller 155A of the display operation device 150 causes the display device 152 to update the display of the jammed position information, including all the jam detection positions except the jam detection position corresponding to the heater unit 312, among the plurality of jam detection positions where the jam has occurred.

The controller 121A of the image forming apparatus 100 transmits the jam occurrence status information including all the jam detection positions where the jam has occurred, to the controller 155A of the display operation device 150 (step S75). The jam occurrence status information transmitted at step S75 only includes the jam detection position corresponding to the heater unit 312, as the jam detection position where the jam has occurred.

The controller 155A of the display operation device 150 causes the display device 152 to display the jam occurrence status information only including the jam detection position corresponding to the heater unit 312, since this is the only position where the jam has occurred at this point (step S76), without displaying “Jam Removal Under Preparation”, because of recognizing that the jam detection position corresponding to the heater unit 312 is now the only jam detection position where the jam has occurred, after receiving the jam removal preparation completion information (that the jam has been removed from all the jam detection positions except the jam detection position corresponding to the heater unit 312, after the heater unit 312 has reached the second position (jam removal position)), on the basis of the jam occurrence status information only including the jam detection position corresponding to the heater unit 312 as the jam detection position where the jam has occurred. The sequence leads to (5-1), (5-2), and (5-3).

The sequence subsequent to (2-1), (2-2), and (2-3), to be followed when the jam has not occurred at the jam detection position corresponding to the heater unit 312, is as described below.

When it is decided at step S55 that the jam detection positions where the jam has occurred do not include the jam detection position corresponding to the heater unit 312 (NO at S55), the controller 121A of the image forming apparatus 100 transmits the jam occurrence status information indicating the jam occurrence status of all the jam detection positions where the jam has occurred, to the controller 155A of the display operation device 150 (step S77).

The controller 155A of the display operation device 150 causes the display device 152 to display the jammed position information including all the jam detection positions where the jam has occurred, on the basis of the jam occurrence status information (step S78). The sequence leads to (5-1), (5-2), and (5-3).

Through the sequence subsequent to (5-1), (5-2), and (5-3), the image forming system 1 according to the second embodiment executes the operation of steps S79 to step S83, which are the same as steps S17 to step S21 executed by the image forming system 1 according to the first embodiment.

According to the second embodiment, when jam occurs at the jam detection position corresponding to the heater unit 312, the jam removal preparation information, indicating that the heater unit 312 is moving from the first position (printing position) toward the second position (jam removal position), as preparation for removing the jam that has occurred at the jam detection position corresponding to the heater unit 312, is displayed on the display device 152. Therefore, the user can be made aware that the jam has occurred at the jam detection position corresponding to the heater unit 312, and also that the preparation for removal of the jam is under preparation, by which the user can be exempted from feeling irritated. In addition, when the heater unit 312 reaches the second position (jam removal position), the jam detection position corresponding to the heater unit 312 is displayed on the display device 152, and therefore the user can promptly start the operation to remove the jam that has occurred at the jam detection position corresponding to the heater unit 312, as soon as the heater unit 312 reaches the second position (jam removal position).

Further, the jam occurrence status information, including all the jam detection positions where the jam has occurred except the jam detection position corresponding to the heater unit 312, is displayed on the display device 152, before the heater unit 312 reaches the second position (jam removal position). Therefore, the user can start the operation to remove the jam from the positions other than the jam detection position corresponding to the heater unit 312, before the heater unit 312 reaches the second position (jam removal position).

For example, when the number of positions where the jam has occurred is equal to or fewer than a predetermined number, the jam removal process executed by the image forming system 1 according to the first embodiment may be adopted, and when the number of positions where the jam has occurred exceeds the predetermined number, the jam removal process executed by the image forming system 1 according to the second embodiment may be adopted. As another example, when the jam occurs only in the drying device, the jam removal process executed by the image forming system 1 according to the first embodiment may be adopted, and when the jam also occurs in the apparatuses other than the drying device, the jam removal process executed by the image forming system 1 according to the second embodiment may be adopted. Thus, the jam removal process according to the first embodiment and that according to the second embodiment may be switched from one to the other, depending on the status of the jam.

In the case of existing image forming systems, including a plurality of jam detection positions where jam (sheet clogging) may occur, and configured to move the heater unit from the first position (printing position) to the second position (jam removal position), when the jam occurs at the jam detection position corresponding to the heater unit, the user may be forced to wait until the heater unit reaches the second position, without being made aware that the jam has occurred at the jam detection position corresponding to the heater unit, which may make the user feel unpleasant. In contrast, with the arrangement according to the foregoing embodiments and variations thereof, when the jam occurs at the jam detection position corresponding to the heater unit provided in the drying device, the user can promptly start the operation to remove the jam as soon as the preparation for removal of the jam is completed, without feeling unpleasant because of being made to wait unaware of the situation related to the preparation for removal of the jam.

The disclosure may be modified in various manners, without limitation to the foregoing embodiment. Further, the configurations and processings according to the first embodiment described with reference to FIG. 1 to FIG. 8, according to the second embodiment described with reference to FIG. 9 to FIG. 14, and according to the foregoing variations are merely exemplary, and in no way intended to limit the disclosure to those configurations and processings.

While the present disclosure has been described in detail with reference to the embodiments thereof, it would be apparent to those skilled in the art that various changes and modifications may be made therein within the scope defined by the appended claims.

What is claimed is:

1. An image forming system comprising:
an image forming apparatus that forms an image on a sheet, by ejecting ink onto the sheet;
a drying device that dries the ink ejected by the image forming apparatus onto the sheet; and
a display apparatus,
the image forming apparatus including:
a first casing;
a first transport device located inside the first casing, and configured to transport the sheet;
an image forming device opposed to the first transport device inside the first casing, and configured to eject the ink onto the sheet; and
a first control device including a first processor,
wherein, when the first processor executes a first control program, the first control device functions as a first controller,
the drying device including:
a second casing;
a second transport device located inside the second casing, and configured to transport the sheet;
a heater unit located inside the second casing, and including a heat source that heats the ink ejected onto the sheet;
a moving mechanism located inside the second casing, and configured to move the heater unit between a first position opposite the second transport device and in a proximity thereof, and a second position more distant from the second transport device than the first position;
a cover that covers the heater unit; and
a second control device including a second processor,
wherein, when the second processor executes a second control program, the second control device functions as a second controller,
the display apparatus including:
a display device; and
a third control device including a third processor,
wherein, when the third processor executes a third control program, the third control device functions as a third controller,
wherein the image forming apparatus and the drying device include a plurality of sensors respectively provided at a plurality of sensor positions located along a transport route on which the sheet is transported, at positions respectively corresponding to a plurality of jam detection positions on the transport route, and each configured to detect jam that occurs at the jam detection position,
the plurality of jam detection positions include the jam detection position corresponding to the heater unit,
upon deciding that the plurality of jam detection positions include one or more jam detection positions where the jam has occurred, and that the jam detection positions where the jam has occurred include the jam detection position corresponding to the heater unit, on a basis of a sensing result of each of the sensors, the first controller of the image forming apparatus:
instructs the second controller of the drying device to move the heater unit from the first position to the second position;
transmits jam removal preparation information, indicating that the heater unit is moving from the first position to the second position, as preparation for removing the jam that has occurred at the jam detection position corresponding to the heater unit, to the third controller of the display apparatus; and
transmits jam occurrence status information, indicating jam occurrence status of all the jam detection positions where the jam has occurred, to the third controller of the display apparatus,
the second controller of the drying device causes the moving mechanism to move the heater unit from the first position to the second position, in accordance with the instruction, and
the third controller of the display apparatus is configured to:
cause the display device to display a message indicating that jam removal is under preparation, according to the jam removal preparation information; and
cause the display device to erase the message indicating that the jam removal is under preparation, when the heater unit reaches the second position, and display jammed position information including all the jam detection positions where the jam has occurred, on a basis of the jam occurrence status information.

2. The image forming system according to claim 1,
wherein the drying device includes a lock that locks the cover in a closed state, and
the second controller causes the lock to unlock the cover from the closed state, when the heater unit reaches the second position.

3. The image forming system according to claim 1,
wherein the drying device includes a temperature sensor that detects a temperature in a proximity of the heater unit, and
the second controller causes the moving mechanism, upon receipt of the instruction from the first controller, to start to move the heater unit from the first position to the second position, when a temperature detected by the temperature sensor becomes equal to or lower than a predetermined temperature.

4. The image forming system according to claim 1,
wherein, upon deciding that the plurality of jam detection positions include one or more jam detection positions where the jam has occurred, and that the jam detection position corresponding to the heater unit is not included in the jam detection positions where the jam has occurred, on the basis of a sensing result from each of the sensors, the first controller of the image forming apparatus transmits the jam occurrence status information, indicating the jam occurrence status of all the jam detection positions, to the third controller of the display apparatus.

5. The image forming system according to claim 1,
wherein the third controller of the display apparatus is configured to:
cause the display device to display first jammed position information, including all the jam detection positions except the jam detection position corresponding to the heater unit, among the plurality of jam detection positions where the jam has occurred, on a basis of the jam occurrence status information, instead of causing the display device to display the message indicating that the jam removal is under preparation, on a basis of the jam removal preparation information, to erase the message indicating that the jam removal is under preparation, when the heater unit reaches the second position, and to display the jammed position information including all the jam detection positions where the jam has occurred, on a basis of the jam occurrence status information;
cause the display device to display the message indicating that the jam removal is under preparation, on a basis of the jam removal preparation information, when the heater unit has not reached the second position before the jam is removed from all the jam detection positions except the jam detection position corresponding to the heater unit;
cause the display device to erase the message indicating that the jam removal is under preparation, when the heater unit reaches the second position; and
cause the display device to display second jammed position information, only including the jam detection position corresponding to the heater unit.
